(19) United States
(12) Patent Application Publication
(10) Pub. No.: US 2021/0120480 A1
(43) Pub. Date: Apr. 22, 2021

(54) ACCESS CONTROL (AC) BARRING METHOD AND APPARATUS

(71) Applicant: Beijing Xiaomi Mobile Software Co., Ltd., Beijing (CN)

(72) Inventor: Yanhua LI, Beijing (CN)

(73) Assignee: Beijing Xiaomi Mobile Software Co., Ltd.

(21) Appl. No.: 17/132,662

(22) Filed: Dec. 23, 2020

Related U.S. Application Data
(63) Continuation of application No. PCT/CN2018/092900, filed on Jun. 26, 2018.

(51) Int. Cl. H04W 48/08; H04W 48/16

(52) U.S. Cl. CPC H04W 48/08; H04W 48/16

(57) ABSTRACT

An access control (AC) barring method applied to a terminal, includes: detecting a Non Access Stratum (NAS) trigger event and an Access Stratum (AS) trigger event which coexist; obtaining an AC barring parameter configured for at least one of the NAS trigger event or the AS trigger event; and performing AC barring on the at least one of the NAS trigger event or the AS trigger event according to the AC barring parameter.

### CROSS REFERENCE TO RELATED APPLICATION

The present application is a continuation of International Application No. PCT/CN2018/092900 filed on Jun. 26, 2018, the entire content of which is incorporated herein by reference.

### TECHNICAL FIELD

The present disclosure relates to the field of communication technology, and in particular, to an access control (AC) barring method and apparatus.

### BACKGROUND

In a Long Term Evolution (LTE) communication system, the working mechanism of Access Control (AC) barring is to obtain corresponding AC barring parameters according to the access class of a terminal and the call type of a call initiated by the terminal in order to perform an AC barring check.

In a New Radio (NR) communication system, a unified AC barring mechanism is introduced. Moreover, the unified AC barring mechanism may be used for terminals in an idle state or in a non-activated state, and may also be used for terminals in a connected state.

However, with respect to the NR communication system, coexisting events may be triggered by a Non Access Stratum (NAS) and an Access Stratum (AS) of a terminal, but currently there is no technical solution provided for performing AC barring on the coexisting events.

### SUMMARY

According to a first aspect of the present disclosure, an access control (AC) barring method applied to a terminal, comprises: detecting a Non Access Stratum (NAS) trigger event and an Access Stratum (AS) trigger event which coexist; obtaining an AC barring parameter configured for at least one of the NAS trigger event or the AS trigger event; and performing AC barring on the at least one of the NAS trigger event or the AS trigger event according to the AC barring parameter.

According to a second aspect of the present disclosure, an access control (AC) barring apparatus comprises: a processor; and a memory for storing instructions executable by the processor, wherein the processor is configured to: detect a Non Access Stratum (NAS) trigger event and an Access Stratum (AS) trigger event which coexist; obtain an AC barring parameter configured for at least one of the NAS trigger event or the AS trigger event; and perform AC barring on the at least one of the NAS trigger event or the AS trigger event according to the AC barring parameter.

According to a third aspect of the present disclosure, a non-transitory computer readable storage medium has stored thereon instructions that, when executed by a processor of a terminal, cause the terminal to perform an access control (AC) barring method, the method comprising: detecting a Non Access Stratum (NAS) trigger event and an Access Stratum (AS) trigger event which coexist; obtaining an AC barring parameter configured for at least one of the NAS trigger event or the AS trigger event; and performing AC barring on the at least one of the NAS trigger event or the AS trigger event according to the AC barring parameter.

The technical solutions provided by the present disclosure may include the following beneficial effects.

According to the present disclosure, after detecting the coexisting NAS trigger event and AS trigger event, the terminal may firstly obtain an AC barring parameter configured for the NAS trigger event and/or the AS trigger event, and then perform AC barring on the NAS trigger event and/or the AS trigger event according to the AC barring parameter, realizing the AC barring on coexisting events, expanding the application range of the AC barring, and improving the flexibility of the AC barring.

It should be understood that the above general description and the following detailed description are only exemplary and explanatory and are not restrictive of the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a flowchart illustrating an access control barring method according to an example of the present application.

FIG. 2 is a schematic diagram illustrating an application scenario of an access control barring method according to an example of the present application.

FIG. 3 is a flowchart illustrating an access control barring method according to an example of the present application.

FIG. 4 is a flowchart illustrating an access control barring method according to an example of the present application.

FIG. 5 is a flowchart illustrating an access control barring method according to an example of the present application.

FIG. 6 is a flowchart illustrating an access control barring method according to an example of the present application.

FIG. 7 is a flowchart illustrating an access control barring method according to an example of the present application.

FIG. 8 is a flowchart illustrating an access control barring method according to an example of the present application.

FIG. 9 is a block diagram illustrating an access control barring apparatus according to an example of the present application.

FIG. 10 is a block diagram illustrating an access control barring apparatus according to an example of the present application.

FIG. 11 is a block diagram illustrating an access control barring apparatus according to an example of the present application.

FIG. 12 is a block diagram illustrating an access control barring apparatus according to an example of the present application.

FIG. 13 is a block diagram illustrating an access control barring apparatus according to an example of the present application.

FIG. 14 is a block diagram illustrating an access control barring apparatus according to an example of the present application.

FIG. 15 is a block diagram illustrating an access control barring apparatus according to an example of the present application.

FIG. 16 is a schematic diagram illustrating an access control barring apparatus according to an example of the present application.

### DETAILED DESCRIPTION OF THE EMBODIMENTS

Examples will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as recited in the appended claims.

Terms used in the present disclosure are for the purpose of describing examples only, and are not intended to limit the present disclosure. For example, the term “and/or” as used herein refers to and includes any and all possible combinations of one or more of the associated listed items. Also for example, although terms “first,” “second,” “third,” and the like may be used in the present disclosure to describe various information, such information should not be limited to these terms. These terms are only used to distinguish one category of information from another. For example, without departing from the scope of the present disclosure, first information may be referred as second information; and similarly, second information may also be referred as first information. Depending on the context, the word “if” as used herein may be interpreted as “when” or “upon” or “in response to determining”.

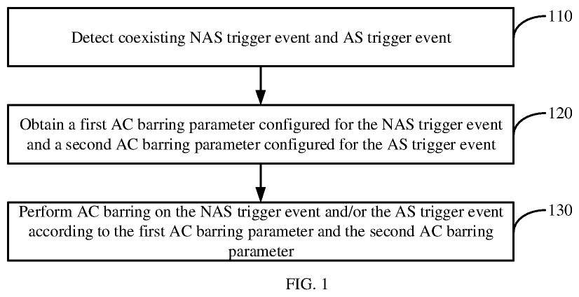

FIG. 1 is a flowchart illustrating an access control barring method according to an example of the present application. The access control barring method may be applied to a terminal, such as user equipment (UE). As shown in FIG. 1, the access control barring method may include the following steps 110 to 130.

At step 110, a NAS trigger event and an AS trigger event which coexist are detected.

In an example of the present disclosure, in the scenario of the coexisting NAS trigger event and AS trigger event, the terminal may perform AC barring on both or either of the NAS trigger event and the AS trigger event according to actual conditions.

In an example, the NAS trigger event may include, but is not limited to, a Tracking Area Update (TAU) trigger event, and the AS trigger event may include, but is not limited to, a Radio Access Network Notification Area Update (RNAU) trigger event. In another example, the NAS trigger event is NAS paging, e.g., core network (CN) paging, while AS trigger event is Radio Access Network (RAN) paging.

At step 120, a first AC barring parameter configured for the NAS trigger event and a second AC barring parameter configured for the AS trigger event are obtained.

In an example of the present disclosure, the terminal may obtain the first AC barring parameter and/or the second AC barring parameter. Parameter values of the first AC barring parameter and the second AC barring parameter may be different. For example, the first AC barring parameter includes a first AC blocking factor, and the second AC barring parameter includes a second AC blocking factor, where the first AC blocking factor is different from the second AC blocking factor.

At step 130, AC barring is performed on the NAS trigger event and/or the AS trigger event according to the first AC barring parameter and the second AC barring parameter.

In an example of the present disclosure, AC barring may be performed on both or either of the NAS trigger event and the AS trigger event according to the first AC barring parameter and the second AC barring parameter.

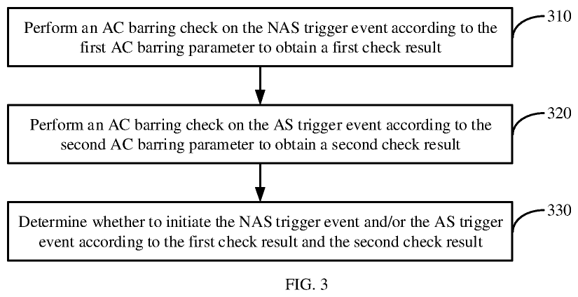

In an example, when AC barring is performed on the NAS trigger event and/or the AS trigger event according to the first AC barring parameter and/or the second AC barring parameter, AC barring may be performed on the NAS trigger event according to the first AC barring parameter, and AC barring may be performed on the AS trigger event according to the second AC barring parameter. For details, reference may be made to examples as shown in FIGS. 3 to 6.

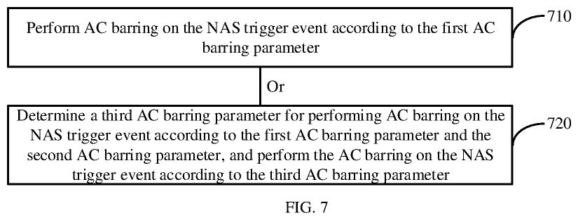

In an example, when AC barring is performed on the NAS trigger event and/or the AS trigger event according to the first AC barring parameter and/or the second AC barring parameter, the first AC barring parameter may be directly used to perform AC barring on the NAS trigger event, or a third AC barring parameter for performing AC barring on the NAS trigger event may be determined firstly according to the first AC barring parameter and the second AC barring parameter, and then the AC barring is performed on the NAS trigger event according to the third AC barring parameter. For details, reference may be made to an example as shown in FIG. 7.

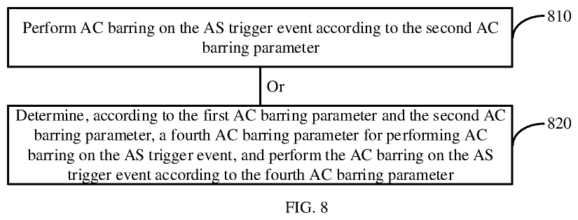

In an example, when AC barring is performed on the NAS trigger event and/or the AS trigger event according to the first AC barring parameter and/or the second AC barring parameter, the second AC barring parameter may be directly used to perform AC barring on the AS trigger event, or a fourth AC barring parameter for performing AC barring on the AS trigger event may be determined firstly according to the first AC barring parameter and the second AC barring parameter, and then the AC barring is performed on the AS trigger event according to the fourth AC barring parameter. For details, reference may be made to an example as shown in FIG. 8.

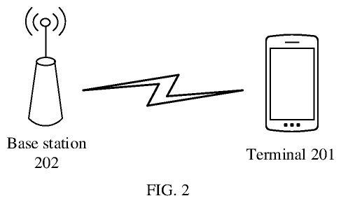

FIG. 2 is a diagram illustrating an application scenario of the access control barring method according to an example of the present application. The application scenario shown in FIG. 2 includes a terminal 201 and a base station 202. After detecting a NAS trigger event and an AS trigger event which coexist, the terminal 201 may firstly obtain a first AC barring parameter configured for the NAS trigger event and a second AC barring parameter configured for the AS trigger event, for example, a first AC barring parameter configured by the base station 202 for the NAS trigger event and a second AC barring parameter configured by the base station 202 for the AS trigger event, and then perform AC barring on the NAS trigger event and/or the AS trigger event according to the first AC barring parameter and the second AC barring parameter. For example, when the NAS trigger event is a TAU trigger event and the AS trigger event is an RNAU trigger event, an AC barring parameter configured for the TAU trigger event and an AC barring parameter configured for the RNAU trigger event may be obtained firstly, and then AC barring is performed on the TAU trigger event and/or the RNAU trigger event according to the AC barring parameter configured for the TAU trigger event and the AC barring parameter configured for the RNAU trigger event.

In the above example, after the coexisting NAS trigger event and AS trigger event are detected, the first AC barring parameter configured for the NAS trigger event and the second AC barring parameter configured for the AS trigger event may be obtained firstly, and then the AC barring is performed on the NAS trigger event and/or the AS trigger event according to the first AC barring parameter and the second AC barring parameter, which realizes the AC barring on coexisting events, expands the application range of the AC barring, and improves the efficiency of the AC barring.

FIG. 3 is a flowchart illustrating an access control barring method according to an example of the present application. The access control barring method may be applied to a terminal and is based on the method shown in FIG. 1. Referring to FIG. 3, performing the AC barring on the NAS trigger event and/or the AS trigger event according to the first AC barring parameter and the second AC barring parameter (step 130 of FIG. 1) may include the following steps 310 to 330.

At step 310, an AC barring check is performed on the NAS trigger event according to the first AC barring parameter to obtain a first check result.

In an example of the present disclosure, the terminal may determine based on the obtained first AC barring parameter that the AC barring check is performed on the NAS trigger event to obtain a first check result, and the AC barring is performed on the NAS trigger event based on the first check result. The first check result may indicate that the AC barring check is passed or not passed.

At step 320, an AC barring check is performed on the AS trigger event according to the second AC barring parameter to obtain a second check result.

In an example of the present disclosure, the terminal may determine based on the obtained second AC barring parameter that the AC barring check is performed on the AS trigger event to obtain a second check result, and the AC barring is performed on the AS trigger event based on the second check result. The second check result may indicate that the AC barring check is passed or not passed.

Step 310 may be performed before step 320, or after step 320, or at the same time as step 320, which is not limited in the present disclosure. Step 310 and step 320 may have an “OR” relationship. In an example, in each of step 310 and step 320, the terminal may determine not to perform the AC barring check but to perform the AC barring directly according to the obtained AC barring parameter.

In an example, the NAS trigger event in the step 310 may include, but is not limited to, a TAU trigger event, and the AS trigger event in the step 320 may include, but is not limited to, an RNAU trigger event. In another example, the NAS trigger event is NAS paging, e.g. core network (CN) paging, while AS trigger event is Radio Access Network (RAN) paging.

At step 330, whether to initiate the NAS trigger event and/or the AS trigger event is determined according to the first check result and the second check result.

In an example of the present disclosure, since the first check result may indicate that an AC barring check is passed or not passed, and the second check result may indicate that an AC barring check is passed or not passed, the terminal may determine whether to perform the AC barring on the AS trigger event or the NAS trigger event according to actual conditions. For example, when it is determined that current RAN is loaded heavily, the base station will notify the terminal that the NAS trigger event is initiated only when both the first check result and the second check result indicate an AC barring check being passed, and otherwise, no operation is initiated. In another example, the terminal may determine, according to the check result of the second AC parameter, whether to perform operations associated with the AS trigger event, so as to achieve the AC barring.

In the above example, the AC barring check is performed on the NAS trigger event according to the first AC barring parameter to obtain the first check result, and/or the AC barring check is performed on the AS trigger event according to the second AC barring parameter to obtain the second check result, then whether to perform the AC barring on the NAS trigger event and/or the AS trigger event is determined according to the first check result and/or the second check result, realizing the simultaneous processing of coexisting events, and improving the reliability of AC barring.

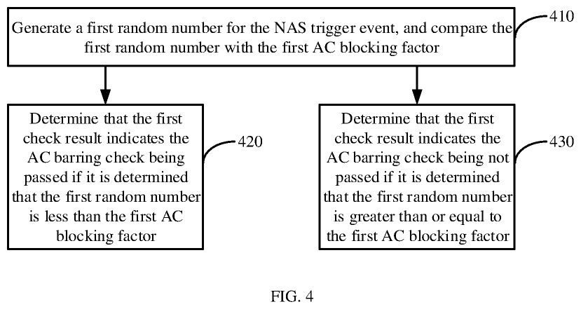

FIG. 4 is a flowchart illustrating an access control barring method according to an example of the present application. The access control barring method may be applied to a terminal and is based on the method shown in FIG. 3. The first AC barring parameter includes a first AC blocking factor. Referring to FIG. 4, step 310 of FIG. 3 may include the following steps 410 to 430.

At step 410, for the NAS trigger event, a first random number is generated, and the first random number is compared with the first AC blocking factor.

In an example of the present disclosure, the first random number may be generated by randomly generating a random number between 0 and 1, and the first random number may be greater or less than or equal to the first AC blocking factor.

At step 420, if it is determined that the first random number is less than the first AC blocking factor, it is determined that the first check result indicates the AC barring check being passed.

At step 430, if it is determined that the first random number is greater than or equal to the first AC blocking factor, it is determined that the first check result indicates the AC barring check being not passed.

In an example of the present disclosure, the first check result indicates that the AC barring check is not passed, representing that a corresponding trigger event is AC barred and it is necessary to be delayed for a period of time before trying to trigger.

In the above example, for the NAS trigger event, the first random number may be generated, and the first random number is compared with the first AC blocking factor. If it is determined that the first random number is less than the first AC blocking factor, it is determined that the first check result indicates the AC barring check being passed. If it is determined that the first random number is greater than or equal to the first AC blocking factor, it is determined that the first check result indicates the AC barring check being not passed. Therefore, the accuracy of AC barring is improved.

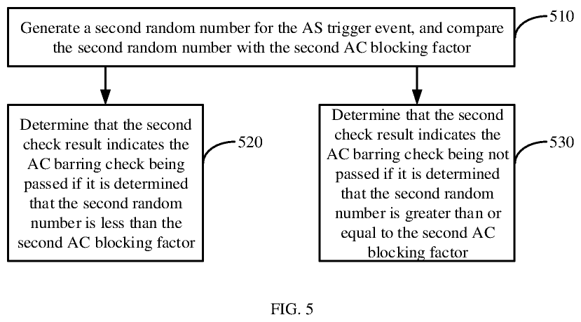

FIG. 5 is a flowchart illustrating another access control barring method according to an example of the present application. The access control barring method may be applied to a terminal and is based on the method shown in FIG. 3. The second AC barring parameter includes a second AC blocking factor. Referring to FIG. 5, step 320 of FIG. 3 may include the following steps 510 to 530.

At step 510, for the AS trigger event, a second random number is generated, and the second random number is compared with the second AC blocking factor.

In an example of the present disclosure, the second random number may be generated by randomly generating a random number between 0 and 1, and the second random number may be greater or less than or equal to the second AC blocking factor.

At step 520, if it is determined that the second random number is less than the second AC blocking factor, it is determined that the second check result indicates the AC barring check being passed.

At step 530, if it is determined that the second random number is greater than or equal to the second AC blocking factor, it is determined that the second check result indicates the AC barring check being not passed.

In an example of the present disclosure, the second check result indicates that the AC barring check is not passed, representing that a corresponding trigger event is AC barred and it is necessary to be delayed for a period of time before trying to trigger.

In the above example, for the AS trigger event, the second random number may be generated, and the second random number may be compared with the second AC blocking factor. If it is determined that the second random number is less than the second AC blocking factor, it is determined that the second check result indicates the AC barring check being passed. If it is determined that the second random number is greater than or equal to the second AC blocking factor, it is determined that the second check result indicates the AC barring check being not passed. Therefore, the accuracy of AC barring is improved.

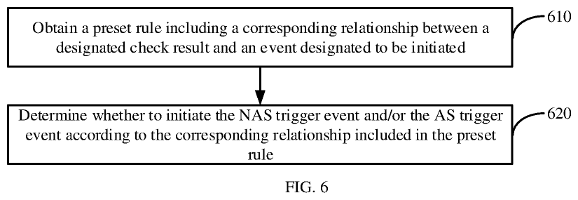

FIG. 6 is a flowchart illustrating an access control barring method according to an example of the present application. The access control barring method may be applied to a terminal and is based on the method shown in FIG. 3. Referring to FIG. 6, step 330 of FIG. 3 may include the following steps 610 to 620.

At step 610, a preset rule is obtained, the preset rule including a corresponding relationship between a designated check result and an event designated to be initiated.

In an example of the present disclosure, the designated check result may be various combinations of the first check result and the second check result. The first check result may indicate an AC barring check being passed or not passed. The second check result may indicate an AC barring check being passed or not passed.

The event designated to be initiated may be a NAS trigger event to be initiated or an AS trigger event to be initiated, or a NAS trigger event and AS trigger event to be initiated.

In an example, the preset rule may be specified based on a communication protocol and/or written in firmware in the terminal; or the preset rule may be configured by a base station, and notified to the terminal through designated signaling.

At step 620, whether to initiate the NAS trigger event and/or the AS trigger event is determined according to the corresponding relationship included in the preset rule.

In an example, step 620 may include but not be limited to one of the following:

(1) if both the first check result and the second check result indicate the AC barring check being passed, determining to initiate only the NAS trigger event; or

(2) if both the first check result and the second check result indicate the AC barring check being passed, determining to initiate only the AS trigger event; or

(3) if the first check result indicates the AC barring check being not passed, and the second check result indicates the AC barring check being passed, determining to initiate only the AS trigger event; or

(4) if the first check result indicates the AC barring check being passed, and the second check result indicates the AC barring check being not passed, determining to initiate only the NAS trigger event; or

(5) if one of the first check result and the second check result indicates the AC barring check being passed, determining to initiate only the AS trigger event; or

(6) if one of the first check result and the second check result indicates the AC barring check being passed, determining to initiate only the NAS trigger event; or

(7) if one of the first check result and the second check result indicates the AC barring check being not passed, determining not to initiate the NAS trigger event or the AS trigger event; or

(8) if both the first check result and the second check result indicate the AC barring check being not passed, determining not to initiate the NAS trigger event or the AS trigger event.

In the above example, whether to initiate the NAS trigger event and/or the AS trigger event may be determined according to the corresponding relationship included in the preset rule. The preset rule may be specified based on the communication protocol and/or written in firmware in the terminal; or the preset rule may be configured by the base station, and notified to the terminal through the designated signaling. Therefore, the accuracy of AC barring is further improved.

FIG. 7 is a flowchart illustrating an access control barring method according to an example of the present application. The access control barring method may be applied to a terminal and is based on the method shown in FIG. 1. Referring to FIG. 7, performing the AC barring on the NAS trigger event and/or the AS trigger event according to the first AC barring parameter and the second AC barring parameter (step 130 of FIG. 1) may include step 710 or step 720.

At step 710, AC barring is performed on the NAS trigger event according to the first AC barring parameter.

In an example of the present disclosure, the first AC barring parameter configured for the NAS trigger event may be directly used for performing the AC barring. For example, the first AC barring parameter is configured by the base station, and notified to the terminal through designated signaling.

In an example, the NAS trigger event may include, but is not limited to, a TAU trigger event. In another example, the NAS trigger event is NAS paging, e.g., core network (CN) paging.

At step 720, a third AC barring parameter for performing AC barring on the NAS trigger event is determined according to the first AC barring parameter and the second AC barring parameter, and the AC barring is performed on the NAS trigger event according to the third AC barring parameter.

In an example of the present disclosure, parameter values of the third AC barring parameter may be determined according to various parameter values of the first AC barring parameter and the second AC barring parameter.

For example, if an AC blocking factor in the first AC barring parameter is greater than an AC blocking factor in the second AC barring parameter, an AC blocking factor in the third AC barring parameter may be the same as the AC blocking factor in the second AC barring parameter.

For another example, if the value of an AC barring timer in the first AC barring parameter is greater than the value of an AC barring timer in the second AC barring parameter, the value of an AC barring timer in the third AC barring parameter may be the same as that of the AC barring timer in the first AC barring parameter.

In an example, the first AC barring parameter includes a first AC blocking factor, the second AC barring parameter includes a second AC blocking factor, and the third AC barring parameter includes a third AC blocking factor, where the third AC blocking factor has a minimum value of the first AC blocking factor and the second AC blocking factor.

In an example, the first AC barring parameter includes a first AC barring timer, the second AC barring parameter includes a second AC barring timer, and the third AC barring parameter includes a third AC barring timer, where the third AC barring timer has a maximum value of the first AC barring timer and the second AC barring timer.

In the above example, the AC barring may be performed on the NAS trigger event directly according to the first AC barring parameter, or the third AC barring parameter for performing AC barring on the NAS trigger event may be determined according to the first AC barring parameter and the second AC barring parameter, and then the AC barring is performed on the NAS trigger event according to the third AC barring parameter, realizing AC barring only on the NAS trigger event, and improving the flexibility of the AC barring.

FIG. 8 is a flowchart illustrating an access control barring method according to an example of the present application. The access control barring method may be applied to a terminal and is based on the method shown in FIG. 1. Referring to FIG. 8, performing the AC barring on the NAS trigger event and/or the AS trigger event according to the first AC barring parameter and the second AC barring parameter (step 130 of FIG. 1) may include step 810 or step 820.

At step 810, AC barring is performed on the AS trigger event according to the second AC barring parameter.

In an example of the present disclosure, the second AC barring parameter configured for the AS trigger event may be directly used for performing the AC barring. For example, the second AC barring parameter is configured by the base station, and notified to the terminal through designated signaling.

In an example, the AS trigger event may include, but is not limited to, an RNAU trigger event. In another example, the AS trigger event is Radio Access Network (RAN) paging.

At step 820, a fourth AC barring parameter for performing AC barring on the AS trigger event is determined according to the first AC barring parameter and the second AC barring parameter, and the AC barring is performed on the AS trigger event according to the fourth AC barring parameter.

In an example of the present disclosure, parameter values of the fourth AC barring parameter may be determined according to various parameter values of the first AC barring parameter and the second AC barring parameter.

For example, if an AC blocking factor in the first AC barring parameter is greater than an AC blocking factor in the second AC barring parameter, an AC blocking factor in the fourth AC barring parameter may be the same as the AC blocking factor in the second AC barring parameter.

For another example, if the value of an AC barring timer in the first AC barring parameter is greater than the value of an AC barring timer in the second AC barring parameter, the value of an AC barring timer in the fourth AC barring parameter may be the same as that of the AC barring timer in the first AC barring parameter.

In an example, the first AC barring parameter includes a first AC blocking factor, the second AC barring parameter includes a second AC blocking factor, and the fourth AC barring parameter includes a fourth AC blocking factor, where the fourth AC blocking factor has a minimum value of the first AC blocking factor and the second AC blocking factor.

In an example, the first AC barring parameter includes a first AC barring timer, the second AC barring parameter includes a second AC barring timer, and the fourth AC barring parameter includes a fourth AC barring timer, where the fourth AC barring timer has a maximum value of the first AC barring timer and the second AC barring timer.

In the above example, the AC barring may be performed on the AS trigger event directly according to the second AC barring parameter, or the fourth AC barring parameter for performing AC barring on the AS trigger event may be determined according to the first AC barring parameter and the second AC barring parameter, and then the AC barring is performed on the AS trigger event according to the fourth AC barring parameter, realizing AC barring only on the AS trigger event, and improving the flexibility of the AC barring.

Corresponding to the access control barring method examples, the present disclosure also provides access control barring apparatus examples.

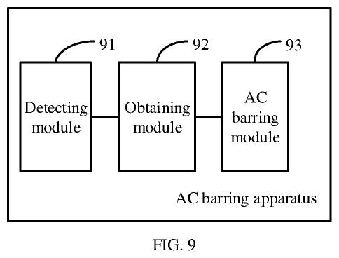

FIG. 9 is a block diagram illustrating an access control barring apparatus according to an example of the present application. The apparatus is applied to a terminal and used to execute the access control barring method shown in FIG. 1. As shown in FIG. 9. the access control barring apparatus may include: a detecting module 91 configured to detect a Non Access Stratum (NAS) trigger event and an Access Stratum (AS) trigger event which coexist; an obtaining module 92 configured to obtain a first AC barring parameter configured for the NAS trigger event and/or a second AC barring parameter configured for the AS trigger event; and an AC barring module 93 configured to perform AC barring on the NAS trigger event and/or the AS trigger event according to the first AC barring parameter and/or the second AC barring parameter.

In the above example, after the coexisting NAS trigger event and AS trigger event are detected, the first AC barring parameter configured for the NAS trigger event and/or the second AC barring parameter configured for the AS trigger event may be obtained firstly, and then the AC barring is performed on the NAS trigger event and/or the AS trigger event according to the first AC barring parameter and the second AC barring parameter, realizing the AC barring on coexisting events, expanding the application range of the AC barring, and improving the efficiency of the AC barring.

In an example, based on the apparatus shown in FIG. 9, the NAS trigger event includes a TAU trigger event, and the AS trigger event includes an RNAU trigger event.

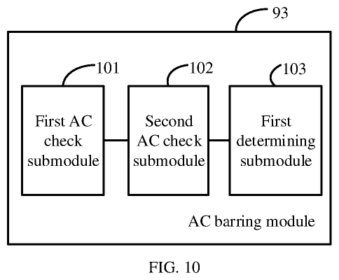

In an example, shown in FIG. 10, the AC barring module 93 (FIG. 9) may include: a first AC check submodule 101 configured to determine based on the first AC barring parameter that an AC barring check is performed on the NAS trigger event to obtain a first check result; a second AC check submodule 102 configured to determine based on the second AC barring parameter that an AC barring check is performed on the AS trigger event to obtain a second check result; and a first determining submodule 103 configured to determine whether to perform the AC barring on the NAS trigger event and/or the AS trigger event according to the first check result and/or the second check result.

In the above example, firstly, the AC barring check is performed on the NAS trigger event according to the first AC barring parameter to obtain the first check result, and/or the AC barring check is performed on the AS trigger event according to the second AC barring parameter to obtain the second check result, then whether to perform the AC barring on the NAS trigger event and/or the AS trigger event is determined according to the first check result and/or the second check result, realizing the simultaneous processing of coexisting events, and improving the reliability of AC barring.

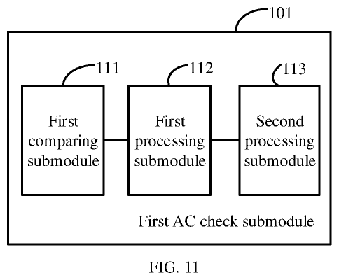

In an example, shown in FIG. 11, the first AC check submodule 101 (FIG. 10) includes: a first comparing submodule 111 configured to, generate a first random number for the NAS trigger event, and compare the first random number with the first AC blocking factor; a first processing submodule 112 configured to, if it is determined that the first random number is less than the first AC blocking factor, determine that the first check result indicates the AC barring check being passed; and a second processing submodule 113 configured to, if it is determined that the first random number is greater than or equal to the first AC blocking factor, determine that the first check result indicates the AC barring check being not passed.

In the above example, for the NAS trigger event, the first random number may be generated, and the first random number is compared with the first AC blocking factor. If it is determined that the first random number is less than the first AC blocking factor, it is determined that the first check result indicates the AC barring check being passed. If it is determined that the first random number is greater than or equal to the first AC blocking factor, it is determined that the first check result indicates the AC barring check being not passed. Therefore, the accuracy of AC barring is improved.

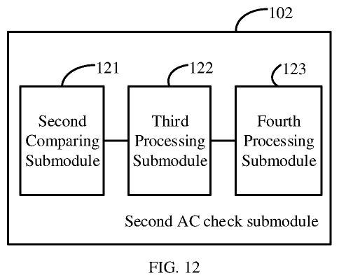

In an example, shown in FIG. 12, the second AC check submodule 102 (FIG. 10) may include: a second comparing submodule 121 configured to, generate a second random number for the AS trigger event, and compare the second random number with the second AC blocking factor; a third processing submodule 122 configured to, if it is determined that the second random number is less than the second AC blocking factor, determine that the second check result indicates the AC barring check being passed; and a fourth processing submodule 123 configured to, if it is determined that the second random number is greater than or equal to the second AC blocking factor, determine that the second check result indicates the AC barring check being not passed.

In the above example, for the AS trigger event, the second random number may be generated, and the second random number may be compared with the second AC blocking factor. If it is determined that the second random number is less than the second AC blocking factor, it is determined that the second check result indicates the AC barring check being passed. If it is determined that the second random number is greater than or equal to the second AC blocking factor, it is determined that the second check result indicates the AC barring check being not passed. Therefore, the accuracy of AC barring is improved.

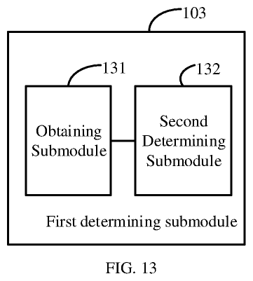

In an example, as shown in FIG. 13, the first determining submodule 103 (FIG. 10) may include: an obtaining submodule 131 configured to obtain a preset rule, wherein the preset rule includes a corresponding relationship between a designated check result and an event designated to be initiated; and a second determining submodule 132 configured to determine whether to initiate the NAS trigger event and/or the AS trigger event according to the corresponding relationship.

In an example, the preset rule is specified based on a communication protocol and/or written in firmware in the terminal; or the preset rule is configured by a base station, and notified to the terminal through designated signaling.

In the above example, whether to initiate the NAS trigger event and/or the AS trigger event may be determined according to the corresponding relationship included in the preset rule. For example, the preset rule may be specified based on the communication protocol and/or written in firmware in the terminal; or the preset rule may be configured by the base station, and notified to the terminal through the designated signaling. Therefore, the accuracy of AC barring is further improved.

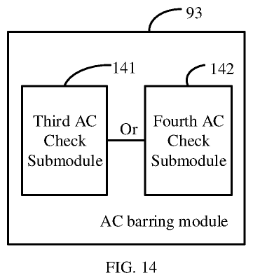

In an example, shown in FIG. 14, the AC barring module 93 (FIG. 9) may include: a third AC check submodule 141 configured to perform AC barring on the NAS trigger event according to the first AC barring parameter; or a fourth AC check submodule 142 configured to determine, according to the first AC barring parameter and the second AC barring parameter, a third AC barring parameter for performing AC barring on the NAS trigger event, and perform the AC barring on the NAS trigger event according to the third AC barring parameter.

In the above example, the AC barring may be performed on the NAS trigger event directly according to the first AC barring parameter, or the third AC barring parameter for performing AC barring on the NAS trigger event may be determined according to the first AC barring parameter and the second AC barring parameter, and then the AC barring is performed on the NAS trigger event according to the third AC barring parameter, realizing AC barring only on the NAS trigger event, and improving the flexibility of the AC barring.

In an example, the first AC barring parameter includes a first AC blocking factor, the second AC barring parameter includes a second AC blocking factor, and the third AC barring parameter includes a third AC blocking factor, wherein the third AC blocking factor has a minimum value of the first AC blocking factor and the second AC blocking factor.

In an example, the first AC barring parameter includes a first AC barring timer, the second AC barring parameter includes a second AC barring timer, and the third AC barring parameter includes a third AC barring timer, wherein the third AC barring timer has a maximum value of the first AC barring timer and the second AC barring timer.

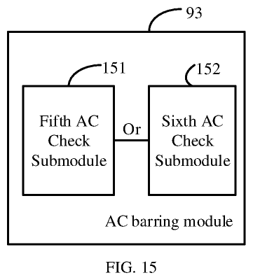

In an example, shown in FIG. 15, the AC barring module 93 (FIG. 9) may include: a fifth AC check submodule 151 configured to perform AC barring on the AS trigger event according to the second AC barring parameter; or a sixth AC check submodule 152 configured to determine, according to the first AC barring parameter and the second AC barring parameter, a fourth AC barring parameter for performing AC barring on the AS trigger event, and perform the AC barring on the AS trigger event according to the fourth AC barring parameter.

In the above example, the AC barring may be performed on the AS trigger event directly according to the second AC barring parameter, or the fourth AC barring parameter for performing AC barring on the AS trigger event may be determined according to the first AC barring parameter and the second AC barring parameter, and then the AC barring is performed on the AS trigger event according to the fourth AC barring parameter, realizing AC barring only on the AS trigger event, and improving the flexibility of the AC barring.

In an example, the first AC barring parameter includes a first AC blocking factor, the second AC barring parameter includes a second AC blocking factor, and the fourth AC barring parameter includes a fourth AC blocking factor, wherein the fourth AC blocking factor has a minimum value of the first AC blocking factor and the second AC blocking factor.

In an example, the first AC barring parameter includes a first AC barring timer, the second AC barring parameter includes a second AC barring timer, and the fourth AC barring parameter includes a fourth AC barring timer, wherein the fourth AC barring timer has a maximum value of the first AC barring timer and the second AC barring timer.

For the apparatus examples, since they basically correspond to the method examples, reference may be made to the description of the method examples. The apparatus examples described above are merely illustrative, wherein the modules described as separate components may or may not be physically separated, and the components displayed as modules may be located in one place or may be distributed to multiple networks. Some or all of the modules may be selected according to actual needs.

The present disclosure also provides a non-transitory computer readable storage medium having thereon instructions that, when executed by a processor of a device, cause the device to perform the access control AC barring method described above.

The present disclosure also provides an access control barring apparatus. The apparatus is applied to a terminal, and includes: a processor; and a memory for storing instructions executable by the processor, wherein the processor is configured to: detect a Non Access Stratum (NAS) trigger event and an Access Stratum (AS) trigger event which coexist; obtain a first AC barring parameter configured for the NAS trigger event and/or a second AC barring parameter configured for the AS trigger event; and perform AC barring on the NAS trigger event and/or the AS trigger event according to the first AC barring parameter and/or the second AC barring parameter.

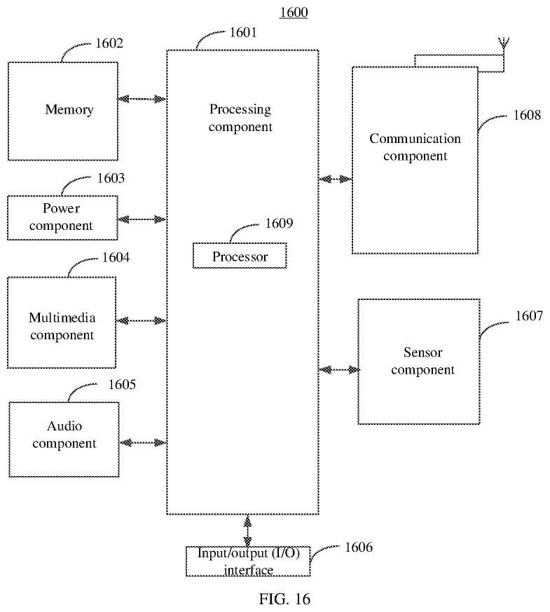

FIG. 16 is a schematic diagram illustrating an access control barring apparatus 1600 according to an example of the present application. The apparatus 1600 may be a terminal such as a computer, a mobile phone, a digital broadcast terminal, a messaging device, a game console, a tablet device, medical equipment, fitness equipment, a personal digital assistant, or other terminals.

Referring to FIG. 16, the apparatus 1600 may include one or more of the following components: a processing component 1601, a memory 1602, a power component 1603, a multimedia component 1604, an audio component 1605, an input/output (I/O) interface 1606, a sensor component 1607, and a communication component 1608.

The processing component 1601 usually controls the overall operation of the apparatus 1600, such as operations associated with display, telephone calls, data communications, camera operations, and recording operations. The processing component 1601 may include one or more processors 1609 to execute instructions to perform all or part of the steps in the methods described above. Moreover, the processing component 1601 may include one or more modules to facilitate interaction between the processing component 1601 and other components. For example, the processing component 1601 may include a multimedia module to facilitate interaction between the multimedia component 1604 and the processing component 1601.

The memory 1602 is configured to store various types of data to support operation at the apparatus 1600. Examples of these data include instructions for any application or method operating at the apparatus 1600, contact data, phone book data, messages, pictures, videos, and the like. The memory 1602 may be implemented by any type of volatile or non-volatile storage device or a combination thereof, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a disk or an optical disk.

The power component 1603 provides power to various components of the apparatus 1600. The power component 1603 may include a power management system, one or more power sources, and other components associated with power generated, managed, and distributed for the apparatus 1600.

The multimedia component 1604 includes a screen that provides an output interface between the apparatus 1600 and a user. In some examples, the screen may include a liquid crystal display (LCD) and a touch panel (TP). If the screen includes a touch panel, the screen may be implemented as a touch screen to receive input signals from the user. The touch panel includes one or more touch sensors to sense touches, slides, and gestures on the touch panel. The touch sensor may not only sense the boundary of touch or slide actions but also detect the duration and pressure associated with touch or slide operations. In some examples, the multimedia component 1604 includes a front camera and/or a rear camera. When the apparatus 1600 is in an operation mode, such as a shooting mode or a video mode, the front camera and/or the rear camera may receive external multimedia data. Each of the front and rear cameras may be a fixed optical lens system or have a focal length and an optical zoom capability.

The audio component 1605 is configured to output and/or input audio signals. For example, the audio component 1605 includes a microphone (MIC) configured to receive an external audio signal when the apparatus 1600 is in an operation mode, such as a call mode, a recording mode, and a voice recognition mode. The received audio signal may be further stored in the memory 1602 or transmitted via the communication component 1608. In some examples, the audio component 1605 also includes a loudspeaker for outputting an audio signal.

The I/O interface 1606 provides an interface between the processing component 1601 and a peripheral interface module which may be a keyboard, a click wheel, a button, or the like. These buttons may include, but are not limited to a home button, a volume button, a start button, and a lock button.

The sensor component 1607 includes one or more sensors for providing a status assessment in various aspects to the apparatus 1600. For example, the sensor component 1607 may detect an open/closed state of the apparatus 1600, and the relative positioning of components, for example, the component is a display and a keypad of the apparatus 1600. The sensor component 1607 may also detect a change in position of the apparatus 1600 or a component of the apparatus 1600, the presence or absence of a user in contact with the apparatus 1600, the orientation or acceleration/deceleration of the apparatus 1600 and a change in temperature of the apparatus 1600. The sensor component 1607 may include a proximity sensor configured to detect the presence of nearby objects without any physical contact. The sensor component 1607 may also include a light sensor, such as a CMOS or CCD image sensor, for use in imaging applications. In some examples, the sensor component 1607 may also include an acceleration sensor, a gyro sensor, a magnetic sensor, a pressure sensor, or a temperature sensor.

The communication component 1608 is configured to facilitate wired or wireless communication between the apparatus 1600 and other devices. The apparatus 1600 may access a wireless network based on a communication standard, such as WiFi, 4G or 5G, or a combination thereof. In an example, the communication component 1608 receives broadcast signals or broadcast associated information from an external broadcast management system via a broadcast channel. In an example, the communication component 1608 also includes a near field communication (NFC) module to facilitate short range communication. In an example, the communication component 1608 may be implemented based on a radio frequency identification (RFID) technology, an infrared data association (IrDA) technology, an ultra wide band (UWB) technology, a Bluetooth (BT) technology, and other technologies.

In an example, the apparatus 1600 may be implemented by one or more application specific integrated circuits (ASICs), digital signal processors (DSPs), digital signal processing devices (DSPDs), programmable logic devices (PLDs), a field programmable gate array (FPGA), a controller, a microcontroller, a microprocessor or other electronic elements for performing the above methods.

In an example, there is also provided a non-transitory computer readable storage medium including instructions, such as the memory 1602 including instructions, where the instructions are executable by the processor 1609 of the apparatus 1600 to perform the method described above. For example, the non-transitory computer readable storage medium may be a ROM, a random access memory (RAM), a CD-ROM, a magnetic tape, a floppy disk, and an optical data storage device. When the instructions in the storage medium are executed by the processor, the apparatus 1600 is configured for executing any of the above-described access control barring methods.

It is to be understood that the present disclosure is not limited to the precise structures that have described and shown in the drawings, and various modifications and changes can be made without departing from the scope thereof. The scope of the disclosure is to be limited only by the appended claims.

1. An access control (AC) barring method applied to a terminal, the method comprising:
detecting a Non Access Stratum (NAS) trigger event and an Access Stratum (AS) trigger event which coexist;
obtaining an AC barring parameter configured for at least one of the NAS trigger event or the AS trigger event;
performing AC barring on the at least one of the NAS trigger event or the AS trigger event according to the AC barring parameter.

2. The method according to claim 1, wherein the NAS trigger event includes a Tracking Area Update (TAU) trigger event, and
the AS trigger event includes a Radio Access Network Notification Area Update (RNAU) trigger event.

3. The method according to claim 1, wherein performing the AC barring on the at least one of the NAS trigger event or the AS trigger event according to the AC barring parameter comprises:
determining, according to the AC barring parameter, to perform an AC barring check; and
determining whether to perform the AC barring on the at least one of the NAS trigger event or the AS trigger event according to a check result of the AC barring check.

4. The method according to claim 3, wherein the AC barring parameter indicates an AC blocking factor, and the AC barring check comprises:
generating a random number for the NAS trigger event, and comparing the random number with the AC blocking factor;
determining that the check result indicates the AC barring check being passed based on a determination that the random number is less than the AC blocking factor; and
determining that the check result indicates the AC barring check being not passed based on a determination that the random number is greater than or equal to the AC blocking factor.

5. The method according to claim 3, wherein determining whether to perform the AC barring on the at least one of the NAS trigger event or the AS trigger event according to the check result of the AC barring check comprises:
determining whether to perform the AC barring on the at least one of the NAS trigger event or the AS trigger event based on the check result and a preset rule.

6. The method according to claim 5, wherein the preset rule is:
specified based on a communication protocol; or
written in firmware in the terminal; or
configured by a base station and notified to the terminal through designated signaling.

7. The method according to claim 1, wherein the AC barring parameter comprises a first AC barring parameter and a second AC barring parameter, and performing the AC barring on the at least one of the NAS trigger event or the AS trigger event according to the AC barring parameter, comprises:
determining, according to the first AC barring parameter and the second AC barring parameter, a third AC barring parameter for performing the AC barring on the NAS trigger event, and performing the AC barring on the NAS trigger event according to the third AC barring parameter.

8. The method according to claim 7, wherein the first AC barring parameter comprises a first AC blocking factor, the second AC barring parameter comprises a second AC blocking factor, and the third AC barring parameter comprises a third AC blocking factor, wherein the third AC blocking factor has a minimum value of the first AC blocking factor and the second AC blocking factor.

9. The method according to claim 7, wherein the first AC barring parameter comprises a first AC barring timer, the second AC barring parameter comprises a second AC barring timer, and the third AC barring parameter comprises a third AC barring timer, wherein the third AC barring timer has a maximum value of the first AC barring timer and the second AC barring timer.

10. The method according to claim 1, wherein the AC barring parameter comprises a first AC barring parameter and a second AC barring parameter, and performing the AC barring on the at least one of the NAS trigger event or the AS trigger event according to the AC barring parameter, comprises:
determining, according to the first AC barring parameter and the second AC barring parameter, a fourth AC barring parameter for performing the AC barring on the AS trigger event, and performing the AC barring on the AS trigger event according to the fourth AC barring parameter.

11. The method according to claim 10, wherein the first AC barring parameter comprises a first AC blocking factor, the second AC barring parameter comprises a second AC blocking factor, and the fourth AC barring parameter comprises a fourth AC blocking factor, wherein the fourth AC blocking factor has a minimum value of the first AC blocking factor and the second AC blocking factor.

12. The method according to claim 10, wherein the first AC barring parameter comprises a first AC barring timer, the second AC barring parameter comprises a second AC barring timer, and the fourth AC barring parameter comprises a fourth AC barring timer, wherein the fourth AC barring timer has a maximum value of the first AC barring timer and the second AC barring timer.

13. An access control (AC) barring apparatus, comprising:
a processor; and
a memory for storing instructions executable by the processor,
wherein the processor is configured to:
detect a Non Access Stratum (NAS) trigger event and an Access Stratum (AS) trigger event which coexist;
obtain an AC barring parameter configured for at least one of the NAS trigger event or the AS trigger event; and
perform AC barring on the at least one of the NAS trigger event or the AS trigger event according to the AC barring parameter.

14. The apparatus according to claim 13, wherein the NAS trigger event includes a Tracking Area Update (TAU) trigger event, and
the AS trigger event includes a Radio Access Network Notification Area Update (RNAU) trigger event.

15. The apparatus according to claim 13, wherein in performing the AC barring on the at least one of the NAS trigger event or the AS trigger event according to the AC barring parameter, the processor is further configured to:
determine, according to the AC barring parameter, to perform an AC barring check; and
determine whether to perform the AC barring on the at least one of the NAS trigger event or the AS trigger event according to a check result of the AC barring check.

16. The apparatus according to claim 15, wherein the AC barring parameter indicates an AC blocking factor, and the AC barring check comprises:
generating a random number for the NAS trigger event, and comparing the random number with the AC blocking factor;
determining that the check result indicates the AC barring check being passed based on a determination that the random number is less than the AC blocking factor; and
determining that the check result indicates the AC barring check being not passed based on a determination that the random number is greater than or equal to the AC blocking factor.

17. The apparatus according to claim 15, wherein in determining whether to perform the AC barring on the at least one of the NAS trigger event or the AS trigger event according to the check result of the AC barring check, the processor is further configured to:
determine whether to perform the AC barring on the at least one of the NAS trigger event or the AS trigger event based on the check result and a preset rule.

18. The apparatus according to claim 17, wherein the preset rule is:
specified based on a communication protocol; or
written in firmware in a terminal; or
configured by a base station and notified to the terminal through designated signaling.

19. The apparatus according to claim 13, wherein the AC barring parameter comprises a first AC barring parameter and a second AC barring parameter, and in performing the AC barring on the at least one of the NAS trigger event or the AS trigger event according to the AC barring parameter, the processor is further configured to:
determine, according to the first AC barring parameter and the second AC barring parameter, a third AC barring parameter for performing the AC barring on the NAS trigger event, and perform the AC barring on the NAS trigger event according to the third AC barring parameter.

20. A non-transitory computer readable storage medium having stored thereon instructions that, when executed by a processor of a terminal, cause the terminal to perform an access control (AC) barring method, the method comprising:
detecting a Non Access Stratum (NAS) trigger event and an Access Stratum (AS) trigger event which coexist;
obtaining an AC barring parameter configured for at least one of the NAS trigger event or the AS trigger event;
performing AC barring on the at least one of the NAS trigger event or the AS trigger event according to the AC barring parameter.
